(19) United States
(12) Patent Application Publication
(10) Pub. No.: US 2015/0167562 A1
(43) Pub. Date: Jun. 18, 2015

(54) VARIABLE COMPRESSION RATIO ENGINE

(71) Applicant: Hyundai Motor Company, Seoul (KR)

(72) Inventor: WON GYU KIM, Seoul (KR)

(73) Assignee: Hyundai Motor Company, Seoul (KR)

(21) Appl. No.: 14/485,461

(22) Filed: Sep. 12, 2014

(30) Foreign Application Priority Data
Dec. 18, 2013 (KR) 10-2013-0158575

(51) Int. Cl. F02D 15/04; F02F 1/00

(52) U.S. Cl. CPC F02D 15/04; F02F 1/004

(57) ABSTRACT

A variable compress ratio engine includes a cylinder bore, a control liner slidably disposed on the cylinder bore, and forming a combustion chamber with the cylinder bore, and an operating unit selectively moving the control liner along the cylinder bore for varying a volume of the combustion chamber.

### CROSS-REFERENCE TO RELATED APPLICATION

The present application claims priority of Korean Patent Application Number 10-2013-0158575 filed on Dec. 18, 2013, the entire contents of which application are incorporated herein for all purposes by this reference.

### BACKGROUND OF INVENTION

1. Field of Invention

The present invention relates to a variable compress ratio engine. More particularly, the present invention relates to a variable compress ratio engine, which varies the compression ratio by increasing or decreasing the volume of a combustion chamber.

2. Description of Related Art

In general, the compression ratio of an internal combustion engine is represented by the largest volume of a combustion chamber prior to compression and the smallest volume of the combustion chamber after compression in a compression stroke of the internal combustion engine.

The output of the internal combustion engine increases as the compression ratio of the internal combustion engine is increased. However, if the compression ratio of the internal combustion engine is too high, so-called knocking occurs, and this even decreases the output of the internal combustion engine and also results in overheating of the internal combustion engine, a failure in a valve or piston of the internal combustion engine, and so on.

Accordingly, the compression ratio of the internal combustion engine is set to a specific value within an appropriate range prior to the occurrence of knocking. As such, because the air-fuel ratio and output of the internal combustion engine can be improved by properly varying the compression ratio according to the load of the internal combustion engine, various approaches are being proposed to vary the compression ratio of the internal combustion engine.

These approaches for varying the compression ratio of the internal combustion engine mostly employ methods that vary the volume of the compression chamber during a compression stroke. For example, there have been proposed methods that vary the height of the top dead center of a piston during a compression stroke, or increase or decrease the volume of a sub-compression chamber provided in a cylinder head.

Varying the height of the top dead center of a piston tends to make the structure of the internal combustion engine complicated. Therefore, it will be desirable to vary the compression ratio by providing a sub-compression chamber in a cylinder head to make the structure simple and achieve great improvement in air-fuel ratio.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a variable compress ratio engine having advantages of varying compression ratio of a cylinder by providing a liner slidable along a bore.

A variable compress ratio engine according to various aspects of the present invention may include a cylinder bore, a control liner slidably disposed on the cylinder bore, and forming a combustion chamber with the cylinder bore, and an operating unit selectively moving the control liner along the cylinder bore for varying a volume of the combustion chamber.

Threads may be formed on an external circumference of the control liner and an internal circumference of the cylinder bore and may be engaged with each other; and the operating unit may include an operating gear connected to the control liner, and an actuator selectively rotating the operating gear to move the control liner along a length direction of the cylinder bore.

The actuator may be a servo motor configured to control a rotation speed and a rotating direction of the operating gear. The variable compress ratio engine according to the present invention may further include a liner ring which is interposed between the control liner and the cylinder bore.

The operating unit may include a hydraulic pressure cylinder, a plunger disposed within the hydraulic pressure cylinder and connected to the control liner, and an oil control valve selectively supplying hydraulic pressure to the hydraulic pressure cylinder for moving the control liner along a length direction of the cylinder bore through the plunger. The variable compress ratio engine according to the present invention may further include a liner ring which is interposed between the control liner and the cylinder bore.

The variable compress ratio engine according to various aspects of the present invention is provided with a liner slidable along a cylinder bore for varying the volume of a combustion chamber according to an operation condition of an engine so that enhancement of fuel consumption may be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 and FIG. 2 are cross-sectional views showing an exemplary variable compress ratio engine according to the present invention.

FIG. 3 is a cross-sectional view showing another exemplary variable compress ratio engine according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration. As those skilled in the art would realize, the described embodiments may be modified in various different ways, all without departing from the spirit or scope of the present invention. A part irrelevant to the description will be omitted to clearly describe the present invention, and the same or similar elements will be designated by the same reference numerals throughout the specification. In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Throughout the specification and the claims, unless explicitly described to the contrary, the word “comprise” and variations such as “comprises” or “comprising”, will be understood to imply the inclusion of stated elements but not the exclusion of any other elements.

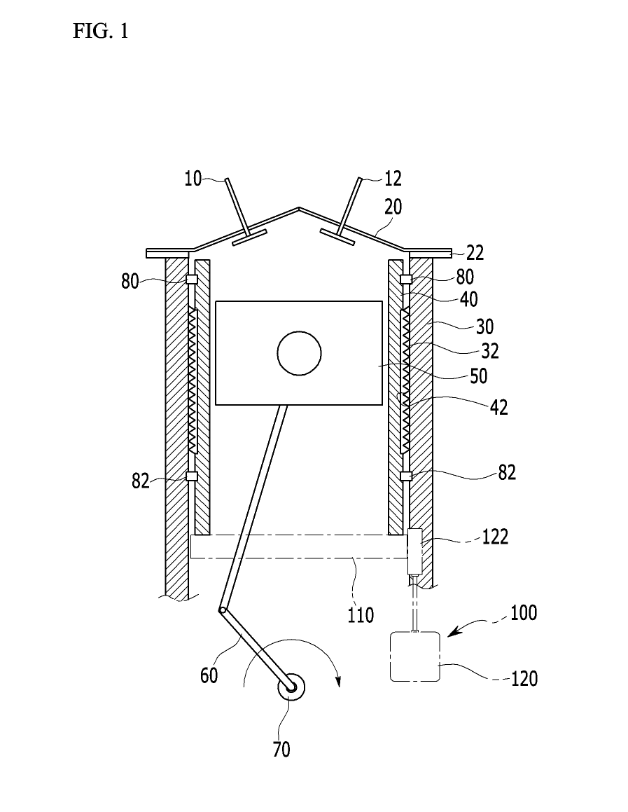

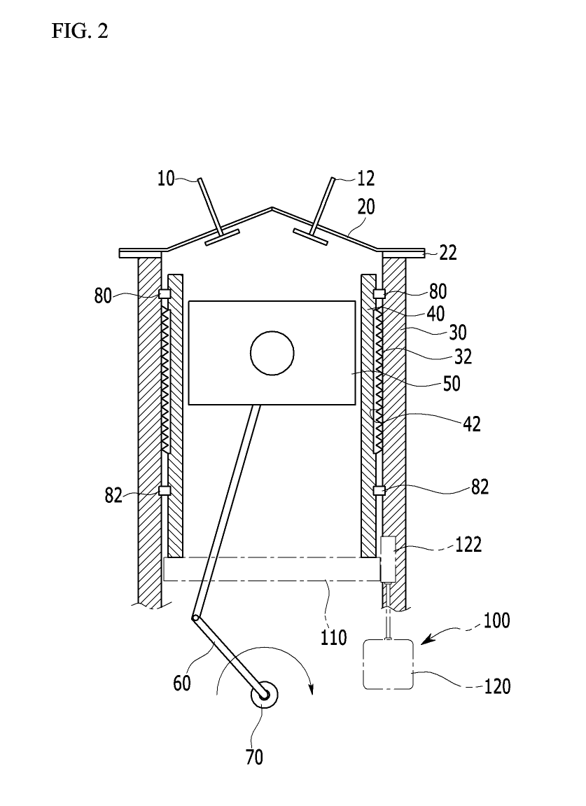

FIG. 1 and FIG. 2 are cross-sectional views showing a variable compress ratio engine according to various embodiments of the present invention. Referring to FIG. 1 and FIG. 2, a variable compress ratio engine the present invention according to various embodiments of the present invention includes a cylinder bore 30 (e.g., a wall or an internal wall of a cylinder), a control liner 40 slidably disposed on the cylinder bore 30, and forming a combustion chamber with the cylinder bore 30, and an operating portion or unit 100 selectively moving the control liner 40 along the cylinder bore 30 for varying volume of the combustion chamber.

The engine includes a cylinder head 20 where an intake valve 10 and an exhaust valve 12 are mounted thereto, the cylinder head 20 is connected to the cylinder bore 30, and a head gasket 22 is interposed between the cylinder head 20 and the cylinder bore 30 for preventing from leakage of combustion gas.

Within the engine, a piston 50 reciprocates along the control liner 40, and the piston 50 is connected to a crankshaft 70 through a connecting rod 60.

Since structures and operations of the intake valve 10, the exhaust valve 12, the piston 50, the connecting rod 60 and the crankshaft 70 are known in the art, and thus detailed description will be omitted.

A control liner thread 42 is formed to an external circumference of the control liner 40, and a cylinder bore thread 32 engaged with the control liner thread 42 is formed to an internal circumference.

The operating portion or unit 100 includes an operating gear 110 connected to the control liner 40, and an actuator 120 selectively rotating the operating gear 110 for the control liner 40 to be moved along the length direction of the cylinder bore 30. The actuator 120 may be a servo motor configured to control rotation speed and rotating direction.

If the actuator 120 is operated to rotate an actuator gear 122, the control liner 40 moves along the length direction of the cylinder bore 30.

A liner ring 80 is interposed between the control liner 40 and the cylinder bore 30, and the liner ring 80 is employed for preventing leakage of combustion gas such as a piston ring.

In some embodiments, the liner ring 80, as shown in the drawings, may be disposed on an upper external circumference of the control liner 40 for preventing leakage of the combustion gas to each of the thread 32 and 42. In some embodiments, the liner rings 80 and 82 may be disposed on an upper and lower external circumferences of the control liner 40 for preventing leakage of the combustion gas to each of the 32 and 42, outside of the engine or the operating portion or unit 100.

Hereinafter, referring to FIG. 1 and FIG. 2, operations of the variable compress ratio engine according to various embodiments of the present invention will be described.

According to engine operation condition, an engine control portion or unit (ECU) controls the operating portion or unit 100 to move the control liner 40 and thus change the relative positions of the control liner 40.

Conventional devices and/or methods may be used to detect the operation conditions of the engine, and thus detailed description will be omitted.

For example, as shown in FIG. 1, in low load of the engine, high compress ratio is realized. That is, the actuator 120 rotates the operating gear 110 through the actuator gear 122 in order that relative position of the control liner 40 moves upward, and then the compress ratio is increased so as to enhance fuel consumption.

On the contrary, in high load of the engine, low compress ratio is realized. That is, the actuator 120 rotates the operating gear 110 through the actuator gear 122 in order that the relative position of the control liner 40 moves downward, and then the compress ratio is reduced so as to improve torque.

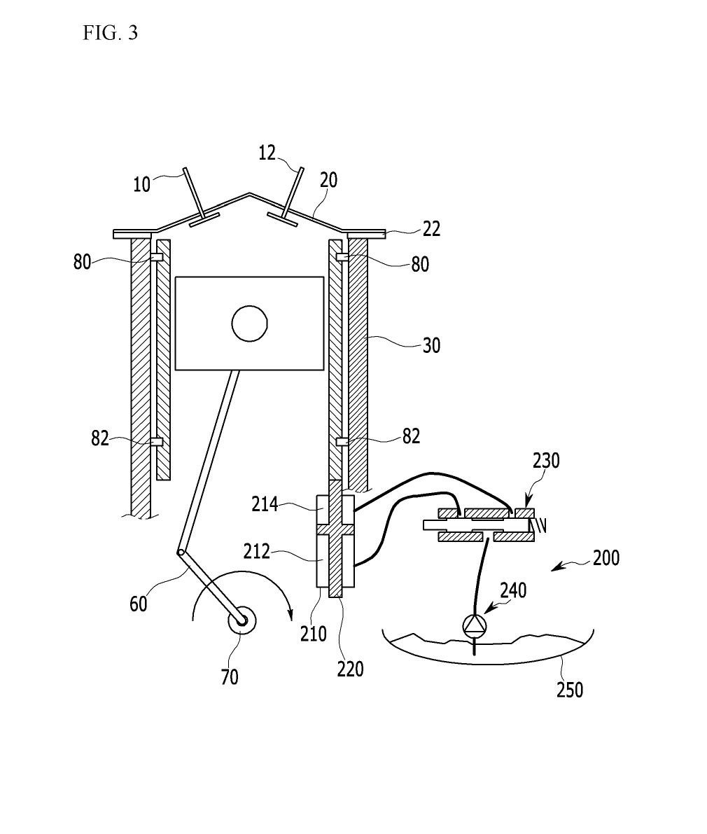

FIG. 3 is a cross-sectional view showing a variable compress ratio engine according to various other embodiments of the present invention. Some components of the variable compress ratio engine illustrated in FIG. 3 is similar or identical to those of the variable compress ratio engine illustrated in FIG. 1 and FIG. 2, and some including connection relationship of the control liner and the cylinder bore and the operating unit are different. Description of those similar or identical components will be omitted.

A control liner 40 of the variable compress ratio engine illustrated in FIG. 3 according to various other embodiments of the present invention is slidably disposed on a cylinder bore 30 (e.g., a wall or an internal wall of a cylinder).

An operating portion 200 of the variable compress ratio engine according to the second exemplary embodiment of the present invention includes a hydraulic pressure cylinder 210, a plunger 220 disposed within the hydraulic pressure cylinder 210 and connected to the control liner, and an oil control valve 230 selectively supplying hydraulic pressure to the hydraulic pressure cylinder 210 for moving the control liner 40 along the length direction of the cylinder bore 30 through the plunger 220.

The oil control valve 230 receives oil in an oil reservoir 250 through a hydraulic pump 240, and the oil control valve 230 supplies hydraulic pressure (oil) to a first chamber 212 or a second chamber 214 of the hydraulic pressure cylinder 210 or releases the hydraulic pressure (oil) of the first chamber 212 or the second chamber 214 of the hydraulic pressure cylinder 210 by the control of the engine control portion.

The relative position of the control liner 40 is variable by the operation of the oil control valve 230 and thus compress ratio of the engine is controlled.

For convenience in explanation and accurate definition in the appended claims, the terms “internal” or “external”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A variable compress ratio engine comprising:
a cylinder bore;
a control liner slidably disposed on the cylinder bore, and forming a combustion chamber with the cylinder bore; and
an operating unit selectively moving the control liner along the cylinder bore for varying a volume of the combustion chamber.

2. The variable compress ratio engine of claim 1, wherein:
threads are formed on an external circumference of the control liner and an internal circumference of the cylinder bore and are engaged with each other; and
the operating unit comprises:
an operating gear connected to the control liner; and
an actuator selectively rotating the operating gear to move the control liner along a length direction of the cylinder bore.

3. The variable compress ratio engine of claim 2, wherein:
the actuator is a servo motor configured to control a rotation speed and a rotating direction of the operating gear.

4. The variable compress ratio engine of claim 2, further comprises:
a liner ring interposed between the control liner and the cylinder bore.

5. The variable compress ratio engine of claim 1, wherein the operating unit comprises:
a hydraulic pressure cylinder;
a plunger disposed within the hydraulic pressure cylinder and connected to the control liner; and
an oil control valve selectively supplying hydraulic pressure to the hydraulic pressure cylinder for moving the control liner along a length direction of the cylinder bore through the plunger.

6. The variable compress ratio engine of claim 5, further comprises:
a liner ring interposed between the control liner and the cylinder bore.
